(19) United States
(12) Patent Application Publication
(10) Pub. No.: US 2013/0153038 A1
(43) Pub. Date: Jun. 20, 2013

(54) APPARATUS AND METHODS FOR PROVIDING FLUID INTO A SUBSEA PIPELINE

(71) Applicants: Andrew J. Barden, Bellaire, TX (US); Alan Paul Sergeant, Kincardineshire (GB)

(72) Inventors: Andrew J. Barden, Bellaire, TX (US); Alan Paul Sergeant, Kincardineshire (GB)

(21) Appl. No.: 13/614,409

(22) Filed: Sep. 13, 2012

Related U.S. Application Data
(60) Provisional application No. 61/535,564, filed on Sep. 16, 2011.
(60) Provisional application No. 61/590,037, filed on Jan. 24, 2012.

(51) Int. Cl. F17D 1/08

(52) U.S. Cl. CPC F17D 1/08
USPC 137/1; 137/899

(57) ABSTRACT

Apparatus useful for at least one among filling, flooding and hydrotesting a subsea pipeline includes a control unit, pump and pump valve disposed upon a submersible skid. The control unit is capable of controlling operation of the pump and pump valve. At least one battery may be disposed upon or associated with the skid for powering the components on the skid.

This application claims priority to U.S. Provisional Patent Application Ser. No. 61/535,564 filed Sep. 16, 2011 and entitled “Apparatus and Methods for Flooding and/or Testing a Subsea Pipeline” and U.S. Provisional Patent Application Ser. No. 61/590,037 filed Jan. 24, 2012 and entitled “Modified Apparatus and Methods for Flooding and/or Testing a Subsea Pipeline”, the disclosures of which are hereby incorporated by reference herein in their entireties.

### FIELD OF THE INVENTION

The present disclosure relates generally to providing fluid into subsea pipelines and, in some embodiments, to apparatus and methods for filling, flooding and/or hydrotesting a subsea pipeline.

### BACKGROUND OF THE INVENTION

Subsea pipeline flooding systems often use the external (sea) water pressure to initially drive a pig, or pig train, inside the pipeline. Typically, the pipeline initially contains air or another gas at a lower pressure than the external water pressure. During the initial flooding efforts, the air in the pipeline ahead of the pig is compressed, causing the air pressure in the pipeline forward of the pig to increase. Eventually the air pressure balances the water pressure in the pipeline and all movement stops or slows significantly.

To complete movement of the pig to the distant end of the pipeline and completely fill the pipeline with water, a boost pump is often used. The objective of filling the pipeline with water is usually to perform a hydrotest, allow the pipeline to be connected underwater to further parts of a pipeline system, or both. A hydrotest is started by pumping additional water into the pipeline with the use of one or more high pressure pump to increase the internal pipeline pressure. The hydrotest typically proves the structural integrity of the pipeline, that the pipeline is free from leaks or both.

Examples of existing skid-mounted pipeline flooding and/or hydrotesting technologies are disclosed in U.S. Pat. No. 5,927,901 to Graves, entitled “Underwater Pipeline Apparatus for Delivering a Pig Unit by Flooding of the Pipeline” and issued on Jul. 27, 1999, U.S. Pat. No. 6,840,088 C1 to Tucker et al., entitled “Subsea Vehicle Assisted Pumping Skid Packages” and issued on Jan. 11, 2005, and U.K. Patent Application Pub. No. GB2390435A filed Jan. 5, 2002 and entitled “Apparatus for and Method of Flooding and/or Pressure Testing Pipelines”, the entire contents of which are hereby incorporated by reference herein.

Presently known skid-mounted pipeline filling, flooding and hydrotesting systems and techniques are believed to have one or more drawbacks. For example, the boost pump and high pressure pump on the system are often powered and/or controlled by a remotely operated vehicle (ROV) or from a floating vessel or other structure at the surface, such as via one or more umbilicals. These requirements for external power and/or control have numerous potential disadvantages. For example, when the same system is used with different ROV's and pipelines, the power provided to the pump(s) may be uncertain, which could lead to unreliable or unpredictable performance. For another example, the need to be linked to an ROV for power and/or control prevents the host vessel from undertaking other activities in other locations. For yet another example, the need to be linked to an ROV makes the entire subsea pipeline servicing (filling, flooding or hydrotesting) operation weather dependant.

It should be understood that the above discussion is provided for illustrative purposes only and is not intended to limit the scope or subject matter of the appended claims or those of any related patent application or patent. Thus, none of the appended claims or claims of any related application or patent should be limited by the above discussion or construed to address, include or exclude each or any of the above-cited examples, features and/or disadvantages, merely because of their mention herein.

Accordingly, there exists a need for improved systems, apparatus and methods useful to assist in filling, flooding and/or hydrotesting underwater pipelines having one or more of the following features, attributes or capabilities, or one of more of the features, attributes or capabilities described or shown in, or as may be apparent from, the other portions of this patent: uses a submersible apparatus that can autonomously drive a pig, fill or hydrotest a subsea pipeline, without the need for power and/or control provided by an underwater vehicle (UV) or from the surface; includes on-board control and power capabilities; is capable of autonomously and selectively starting and stopping a boost and/or high pressure pump and controlling a boost and/or high pressure pump valve without power or control sources from a UV or via an umbilical or cable to the surface; includes a submersible, on-board control unit for controlling all functions relating to flooding and/or hydrotesting a subsea pipeline; includes an on-board control unit that monitors data from at least one flow meter and/or at least one pressure sensor and controls functioning of the valves and pumps needed for flooding and/or hydrotesting in accordance with programmable logic; includes an on-board valve power assembly configured to selectively open and close valves; includes an on-board battery configured to provide one among direct current (DC), single-phase alternating current (AC) or 3-phase AC power, and may be configured to drive a hydraulic power unit; includes any among various forms of speed control for a boost pump and/or hydrotest pump; includes a pressure relief manifold to protect the pipeline from over-pressure and reduce pressure after hydrotesting.

### BRIEF SUMMARY OF THE DISCLOSURE

In some embodiments, the present disclosure involves apparatus for filling and/or flooding a subsea pipeline. The apparatus includes a submersible skid configured to be deployed to the vicinity of the pipeline and at least one fluid conduit disposed at least partially upon the skid and fluidly engageable with the pipeline. At least one pump is mounted on the skid and configured to pump fluid through the fluid conduit into the pipeline for filling and/or flooding the pipeline. At least one pump valve is disposed upon the skid and associated with the pump. At least one fluid flow meter is configured to measure the fluid flow rate in the fluid conduit. At least one control unit is disposed upon the skid and configured to control the operation of the pump and the pump valve, receive data from the fluid flow meter, and actuate the pump valve and pump at least partially based upon data from the fluid flow meter. At least one battery is associated with the skid and configured to provide sufficient power to the pump and the control unit for performing at least one among filling and flooding of the subsea pipeline without power being provided to the skid from an underwater vehicle or through a cable from the surface. In some embodiments, at least one battery is disposed on the skid and the skid is autonomously powered.

The present disclosure also includes embodiments involving an apparatus for hydrotesting a subsea pipeline which include a submersible skid configured to be deployed to the vicinity of the pipeline. At least one fluid conduit is disposed at least partially upon the skid and fluidly engageable with the pipeline. At least one pump is mounted on the skid and configured to pump fluid through the fluid conduit into the pipeline for hydrotesting the pipeline. At least one pump valve is disposed upon the skid and associated with the pump. At least one pressure sensor is configured to measure the pressure of fluid flowing into the pipeline from the fluid conduit. At least one control unit is disposed upon the skid and configured to receive data from the pressure sensor and control the operation of the pump and pump valve. At least one battery is associated with the skid and configured to provide sufficient power to The pump and the control unit for performing hydrotesting of the pipeline without power being provided to the skid from an underwater vehicle or through a cable from the surface. In some embodiments, at least one battery is disposed on the skid and the skid is autonomously powered.

In various embodiments, the present disclosure involves apparatus for autonomously controlling at least one among filling, flooding and hydrotesting a subsea pipeline. The apparatus includes a submersible skid configured to be deployed to the vicinity of the pipeline and at least one fluid conduit disposed at least partially upon the skid and fluidly engageable with the pipeline. At least one pump is mounted on the skid and configured to pump fluid through the fluid conduit into the pipeline for at least one among filling, flooding and hydrotesting the pipeline. At least one pump valve is disposed upon the skid and associated with the pump. At least one control unit is disposed upon the skid and configured to autonomously control operation of the pump valve and the pump necessary for performing at least one among filling, flooding and hydrotesting of the pipeline without involvement of an underwater vehicle or other external source for controlling functions on the skid relating thereto.

The present disclosure also includes embodiments involving a method of flooding a subsea pipeline having at least one pig disposed therein. These methods use a deployable skid and at least one battery associated with the skid and not connected to an underwater vehicle or cable extending to the surface, The skid includes a control unit, a fluid conduit connectable with the pipeline and at least one pump, pump valve and flow meter associated with the fluid conduit. These methods include lowering the skid to the sea bed and fluidly connecting the fluid conduit to the pipeline. The control unit is turned on while ensuring the pump valve is closed. A pipeline valve associated with the pipeline is opened. The natural flow of sea water is allowed through the fluid conduit into the pipeline. The control unit monitors the flow rate in the fluid conduit via the flow meter, opens the pump valve and turns on the pump. The pump valve allows the flow of fluid from the pump into the fluid conduit, and the pump pumps fluid through the fluid conduit into the pipeline. The control unit turns off the pump based upon one or more among the flow rate in the fluid conduit, the passage of a certain duration of time or when the pig reaches the distant end of the pipeline. The battery provides sufficient power to the pump and control unit for flooding the pipeline, whereby power to the skid from an underwater vehicle or cable to the surface is not required for flooding the pipeline. In some embodiment, at least one battery may be disposed on the skid.

In many embodiments, the present disclosure involves a method of flooding a subsea pipeline having at least one pig disposed therein. These methods use a deployable skid that includes a control unit, a fluid conduit connectable with the pipeline and at least one pump, pump valve and flow meter associated with the fluid conduit. In these methods, the control unit autonomously controls all operations on the skid relating to flooding of the pipeline without involvement of an underwater vehicle or other external control source for controlling operations on the skid necessary for flooding the pipeline.

The present disclosure also includes embodiments involving a method of hydrotesting a subsea pipeline. These methods use a deployable skid and at least one battery associated with the skid and not connected to an underwater vehicle or cable extending to the surface. The skid includes a control unit, a fluid conduit connectable with the pipeline and at least one high pressure pump, pump valve and pressure sensor associated with the fluid conduit. These methods include lowering the skid to the sea bed, fluidly connecting the fluid conduit to the pipeline, turning on the control unit and opening the pump valve. The pressure sensor measures the pressure of fluid flowing into the pipeline from the fluid conduit. The control unit turns on the high pressure pump, which pumps fluid through the fluid conduit into the pipeline. The control unit receives data from the pressure sensor and turns off the high pressure pump when the pressure is at or above a certain level based at least partially upon data received from the pressure sensor. The battery provides sufficient power to the pump and control unit for hydrotesting the pipeline, whereby power to the skid from an underwater vehicle or cable to the surface is not required for hydrotesting the pipeline. In some embodiment, at least one battery may be disposed on the skid.

The present disclosure also includes embodiments involving a method of hydrotesting a subsea pipeline with a deployable skid that includes a control unit, a fluid conduit connectable with the pipeline and at least one high pressure pump, pump valve and pressure sensor associated with the fluid conduit. In these methods, the control unit receives data from the pressure sensor and turns off the high pressure pump when the pressure reaches or exceeds a certain level based at least partially upon data received from the pressure sensor and autonomously controls all operations on the skid relating to hydrotesting the pipeline without involvement of an underwater vehicle other external source for controlling such operations.

Accordingly, the present disclosure includes features and advantages which are believed to enable it to advance subsea pipeline servicing technology. Characteristics and advantages of the present disclosure described above and additional features and benefits will be readily apparent to those skilled in the art upon consideration of the following detailed description of various embodiments and referring to the accompanying drawings.

### BRIEF DESCRIPTION OF THE DRAWINGS

The following figures are part of the present specification, included to demonstrate certain aspects of various embodiments of this disclosure and referenced in the detailed description herein:

FIG. 1 is a diagrammatic view of an exemplary subsea pipeline servicing system shown engaged with a pipeline on the sea bed in accordance with an embodiment of the present disclosure;

FIG. 2 is a block diagram of an embodiment of a power configuration of the subsea pipeline servicing system of FIG. 1;

FIG. 3 is a block diagram of another embodiment of a power configuration of the subsea pipeline servicing system of FIG. 1;

FIG. 4 is a block diagram of another embodiment of a power configuration of the subsea pipeline servicing system of FIG. 1;

FIG. 5 is a block diagram of another embodiment of a power configuration of the subsea pipeline servicing system of FIG. 1;

FIG. 6 is a block diagram of another embodiment of a power configuration of the subsea pipeline servicing system of FIG. 1;

FIG. 7 is a block diagram of another embodiment of a power configuration of the subsea pipeline servicing system of FIG. 1;

FIG. 8 is a block diagram of another embodiment of a power configuration of the subsea pipeline servicing system of FIG. 1;

FIG. 9 is a diagrammatic view of an exemplary subsea pipeline servicing system shown engaged with a pipeline on the sea bed in accordance with another embodiment of the present disclosure;

FIG. 10 is a block diagram of an embodiment of a power configuration of the subsea pipeline servicing system of FIG. 9;

FIG. 11 is a diagrammatic view of an exemplary subsea pipeline servicing system shown engaged with a pipeline on the sea bed in accordance with yet another embodiment of the present disclosure;

FIG. 12 is a diagrammatic view of an exemplary subsea pipeline servicing system shown engaged with a pipeline on the sea bed in accordance with still a further embodiment of the present disclosure; and

FIG. 13 is a block diagram of an embodiment of a power configuration of the subsea pipeline servicing system of FIG. 12.

### DETAILED DESCRIPTION OF PREFERRED EMBODIMENTS

Characteristics and advantages of the present disclosure and additional features and benefits will be readily apparent to those skilled in the art upon consideration of the following detailed description of exemplary embodiments of the present disclosure and referring to the accompanying figures. It should be understood that the description herein and appended drawings, being of example embodiments, are not intended to limit the claims of this patent or any patent or patent application claiming priority hereto. On the contrary, the intention is to cover all modifications, equivalents and alternatives falling within the spirit and scope of the claims. Many changes may be made to the particular embodiments and details disclosed herein without departing from such spirit and scope.

In showing and describing preferred embodiments in the appended figures, common or similar elements are referenced with like or identical reference numerals or are apparent from the figures and/or the description herein. When multiple figure refer to a component or feature with the same reference numeral, any description herein of the component or feature with respect to any of the figures applies equally to the other figures to the extent such description does not conflict with a description herein of the other figure(s). The figures are not necessarily to scale and certain features and certain views of the figures may be shown exaggerated in scale or in schematic in the interest of clarity and conciseness.

As used herein and throughout various portions (and headings) of this patent application, the terms “invention”, “present invention” and variations thereof are not intended to mean every possible embodiment encompassed by this disclosure or any particular claim(s). Thus, the subject matter of each such reference should not be considered as necessary for, or part of, every embodiment hereof or of any particular claim(s) merely because of such reference. The terms “coupled”, “connected”, “engaged” and the like, and variations thereof, as used herein and in the appended claims are intended to mean either an indirect or direct connection or engagement. Thus, if a first device couples to a second device, that connection may be through a direct connection, or through an indirect connection via other devices and connections.

Certain terms are used herein and in the appended claims to refer to particular components. As one skilled in the art will appreciate, different persons may refer to a component by different names. This document does not intend to distinguish between components that differ in name but not function. Also, the terms “including” and “comprising” are used herein and in the appended claims in an open-ended fashion, and thus should be interpreted to mean “including, but not limited to . . . .” Further, reference herein and in the appended claims to components and aspects in a singular tense does not necessarily limit the present disclosure or appended claims to only one such component or aspect, but should be interpreted generally to mean one or more, as may be suitable and desirable in each particular instance.

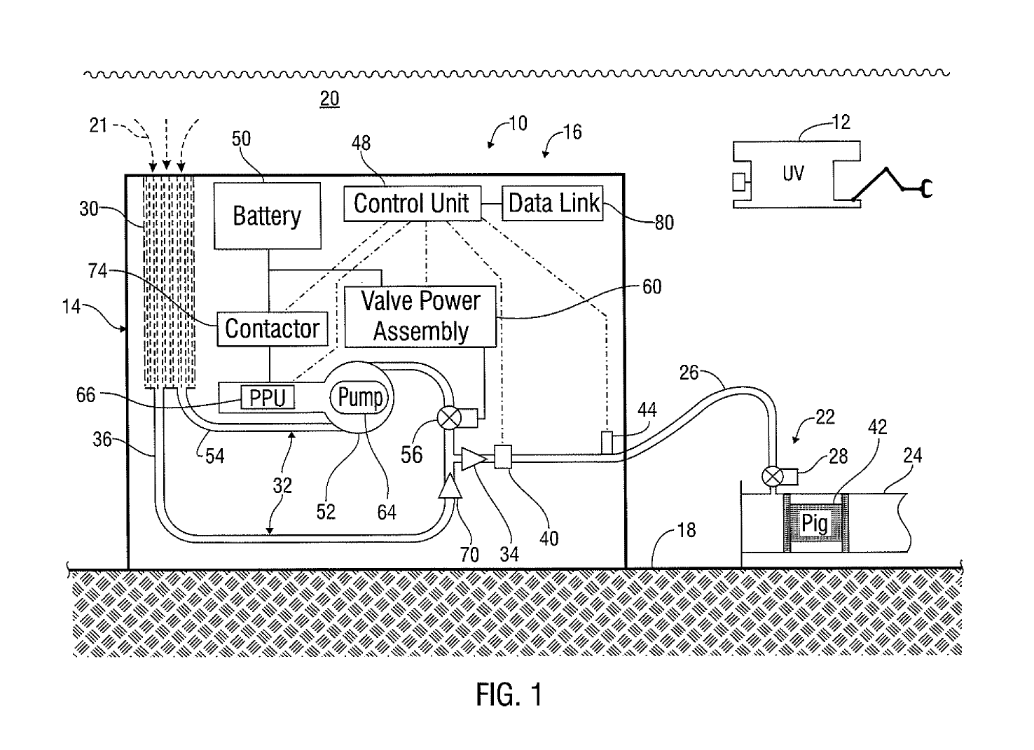

Referring initially to FIG. 1, an embodiment of a subsea pipeline servicing system 10 includes various components mounted or supported on a skid frame 14. As used herein and in the appended claims, the term “subsea pipeline servicing system” and variations thereof means a system useful for or capable of at least one among filling, flooding or hydrotesting a subsea pipeline. As used herein and in the appended claims, the term “filling” and variations thereof, means providing fluid into an entire pipeline or any desired portion thereof. The fluid may be any suitable desired liquid and may include chemicals, other substances, particles or a combination thereof. For example, a filling operation may involve pumping hydrate inhibiting fluid (e.g. including methanol or glycol) into a pipeline to stop natural gas in the pipeline from forming hydrates therein. The skid frame 14 is shown located on the sea floor 18 situated proximate to the end 22 of a pipeline, or pipeline manifold, 24. The illustrated skid frame 14 may have any desired construction, configuration and operation suitable to provide sufficient support for all components of the system 10, such as during transport, deployment operation, storage, maintenance and retrieval.

A jumper 26 is shown connected between the skid frame 14 and the pipeline 24, as is and becomes further known. The jumper 26 may have any desired construction, configuration and operation suitable to provide a fluid connection between the system 10 and the pipeline 24. The jumper 26 may, for example, include flexible pipe and/or a loading arm with hinged joints, such as may be useful for spanning varying distances, angles and heights of the skid frame 14 relative to the pipeline 24. For another example, the jumper 26 may be a rigid pipe extending from the skid frame 14.

Still referring to the embodiment of FIG. 1, the various components of the system 10 may have any suitable construction, configuration and operation. In this example, the system 10 includes one or more inlet filters 30 in fluid communication with one or more fluid conduit, or piping, 32 on the skid frame 14. The illustrated filter 30 allows the inflow of sea water 20 (e.g. arrows 21) into the piping 32 and ultimately into the pipeline 24. If desired, the exemplary filter 30 may be configured to remove at least some suspended particles from the incoming sea water 20, such as to satisfy the particular specifications of the pipeline 24 and/or protect the piping 32 and one or more pump on the skid frame 14 from erosion and malfunction caused thereby. While the illustrated filter 30 is a single unit cylindrical filter, the filter 30 may have any suitable geometric configuration and include one or multiple discrete filter elements. For example, the filter 30 may include one or more flat, or mat-like, elements (not shown) supported on a sub-frame (not shown) mounted within the skid frame 14. For another example, the filter 30 may be mounted above, or extend from, the top 16 of the skid frame 14, such as to distance the filter 30 from disturbances on the sea floor 18.

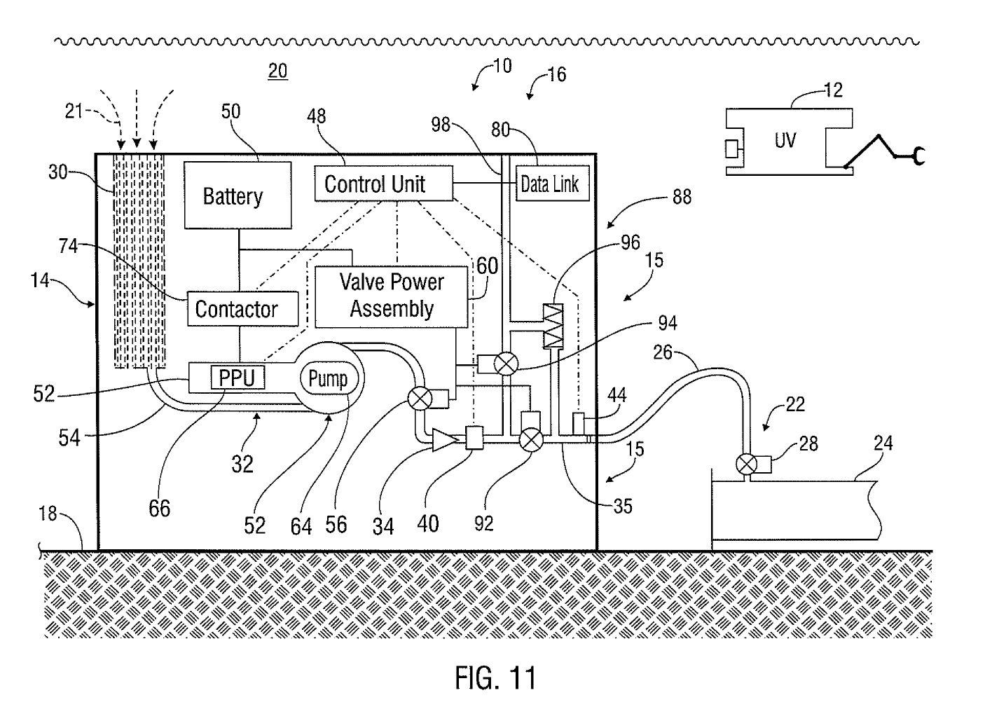

In this example, the jumper 26 is shown extending onto the skid frame 14 and engaging a first non-return valve 34 of the system 10. However, in other embodiments, such as shown in FIG. 11, the jumper 26 may connect to the piping 32, such as, for example, at a pipe section 35 extending proximate to the edge 15 of the skid frame 14.

The illustrated first non-return valve 34 is configured to hold the fluid pressure in the piping 32 and jumper 26 forward of the valve 34, preventing undesirable or unexpected back-flow of fluid from the pipeline 24 into the system 10 and potentially through the inlet filter 30 and into the sea. For example, the pipeline 24 may be connected by a manifold to another pipeline having a higher internal fluid pressure than that of the pipeline 24. The isolation between the two pipelines may leak, resulting in a rise in fluid pressure in the pipeline 24, causing a potential undesirable back-flow of fluid into the system 10.

Still referring to the embodiment of FIG. 1, the piping 32 includes a pump bypass line 36 extending between the inlet filter 30 and jumper 26. The illustrated pump bypass line 36 allows the flow of sea water 20 from the inlet filter 30 to the pipeline 24 without the use of any pumps, such as may be useful during initial pipeline flooding operations.

The exemplary system 10 also includes at least one flow meter 40 and control unit 48. The illustrated flow meter 40 is situated and configured to measure the flow rate of fluid passing through the system 10 to the pipeline 24 and communicate such data to the control unit 48. The flow meter(s) 40 may be of any suitable type and configuration, as is or becomes further known. For example, the flow meter 40 may be of a type which water flows through or past.

The system may also include at least one pressure sensor 44. However, a pressure sensor 44 may not be included or necessary for various filling and flooding operations. The illustrated pressure sensor 44 is configured to measure the pressure of fluid passing through the system 10 to the pipeline 24 and communicate such data to the control unit 48. The pressure sensor 40 may also be of any suitable type and configuration, as is or becomes further known.

The flow meter(s) 40 and pressure sensor(s) 44 may be positioned at any suitable location on the jumper 26 or piping 32. In this embodiment, the flow meter 40 and pressure sensor 44 are shown engaged with the jumper 26. The illustrated pressure sensor 44 is positioned within the skid frame 14 as close as practical to the pipeline 24, such as to provide pressure measurements as close as possible to the fluid pressure in the pipeline 24. In other embodiments, the pressure sensor 44 may instead be located closely adjacent to the end 22 of the pipeline 24 (on the jumper 26) or on the pipeline 24 itself. Also if desired, the flow meter 40 may be positioned proximate to the pressure sensor 44, such as to simplify installation of cabling from these components to the control unit 48.

Still referring to the embodiment of FIG. 1, the subsea pipeline servicing system 10 also includes at least one battery 50, pump assembly 52, pump valve 56 and valve power assembly 60 disposed on the skid frame 14. The exemplary pump assembly 52 includes a fluid pump 64 and a pump power unit 66. The illustrated fluid pump 64 is in fluid communication with the piping 32 between the inlet filter 30 and the jumper 26.

The fluid pump 64 and pump power unit 66 may be of any suitable type and configuration and disposed in any suitable location. The illustrated fluid pump 64 is a variable speed water pump of sufficient capacity to serve as a boost pump capable of moving a pig, or pig train, 42 in the pipeline 24 to the distant end thereof. It should be noted that the exemplary pig 42 is shown proximate to the end 22 of the pipeline 24 for illustrative purposes. However, the pig 42 may be positioned at different locations within the pipeline 24. In some applications, there may be no pig 42 in the pipeline 24. Thus, the inclusion of and position of the pig 42 is not limiting upon the present disclosure or appended claims.

The exemplary pump power unit 66 drives the fluid pump 64 using power from the battery 50 and based upon commands from the control unit 48. In this embodiment, the fluid pump 64 is disposed on a pump line 54 between the inlet filter 30 and the first non-return valve 34. Some potential example configurations of the pump power unit 66 are: (i) a direct-current (DC) submersible electric motor, (ii) an inverter and a single phase alternating-current (AC) submersible electric motor, (iii) an inverter or multiple synchronized inverters providing 3-phase alternating-current and a 3-phase AC submersible electric motor, and (iv) any of the above submersible electric motors driving a hydraulic power unit, which drives a hydraulic motor. When one or more inverters are used, a current-limiting device for starting the electric motor may also be used.

The pump valve 56 and valve power assembly 60 may likewise have any suitable configuration, construction and operation. In this embodiment, the pump valve 56 is configured to allow or disallow fluid flow from the fluid pump 64 through the piping 32 to the jumper 26, and assists in protecting the pump 64 from the effects of excessive differential pressure when the pipeline valve 28 is first opened. The illustrated pump valve 56 also includes an actuator (not shown), such as an electrically or hydraulically powered actuator depending upon the configuration of the valve power assembly 60.

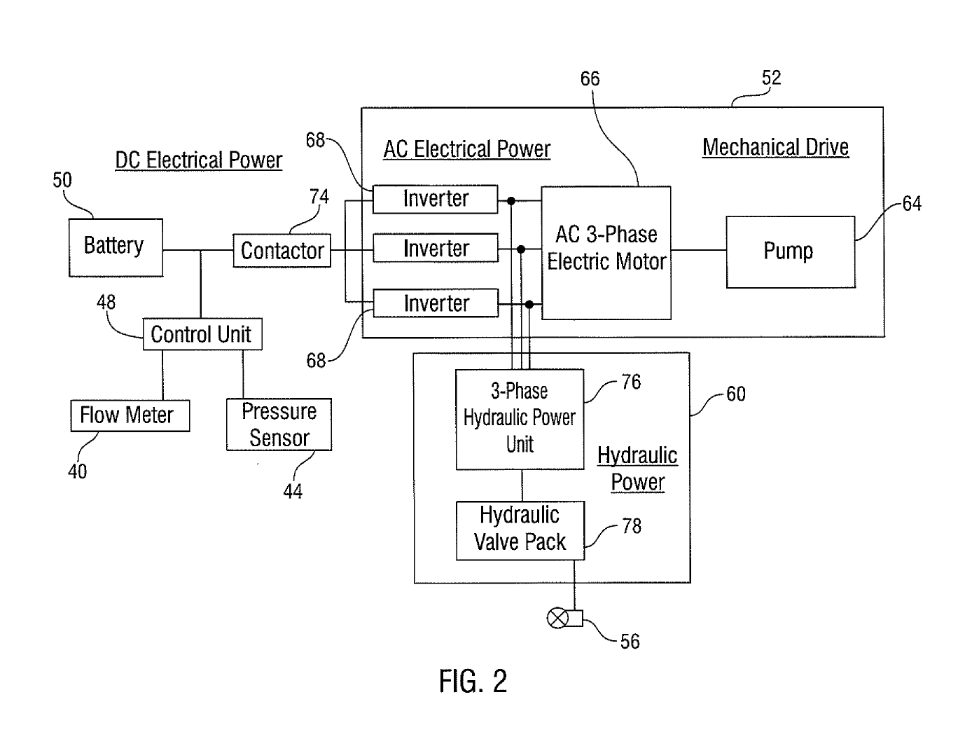

Still referring to the embodiment of FIG. 1, the illustrated valve power assembly 60 is controlled by the control unit 48, powered by the battery 50 and configured to open or close the pump valve 56 based upon commands from the control unit 48. The valve power assembly 60 may have any suitable configuration, construction and operation. FIG. 2 illustrates one potential configuration of the valve power assembly 60 and an exemplary overall power supply arrangement for the system 10. In this example, the valve power assembly 60 includes a 3-phase AC hydraulic power unit 76 and a hydraulic valve pack 78 for driving the pump valve 56. Power is supplied to the valve power assembly 60 by one or more inverters 68 in the pump assembly 52 that converts the DC power of the battery 50 to AC. The illustrated pump power unit 66 of the pump assembly 52 is a 3-phase AC electric motor, which mechanically drives the fluid pump 64.

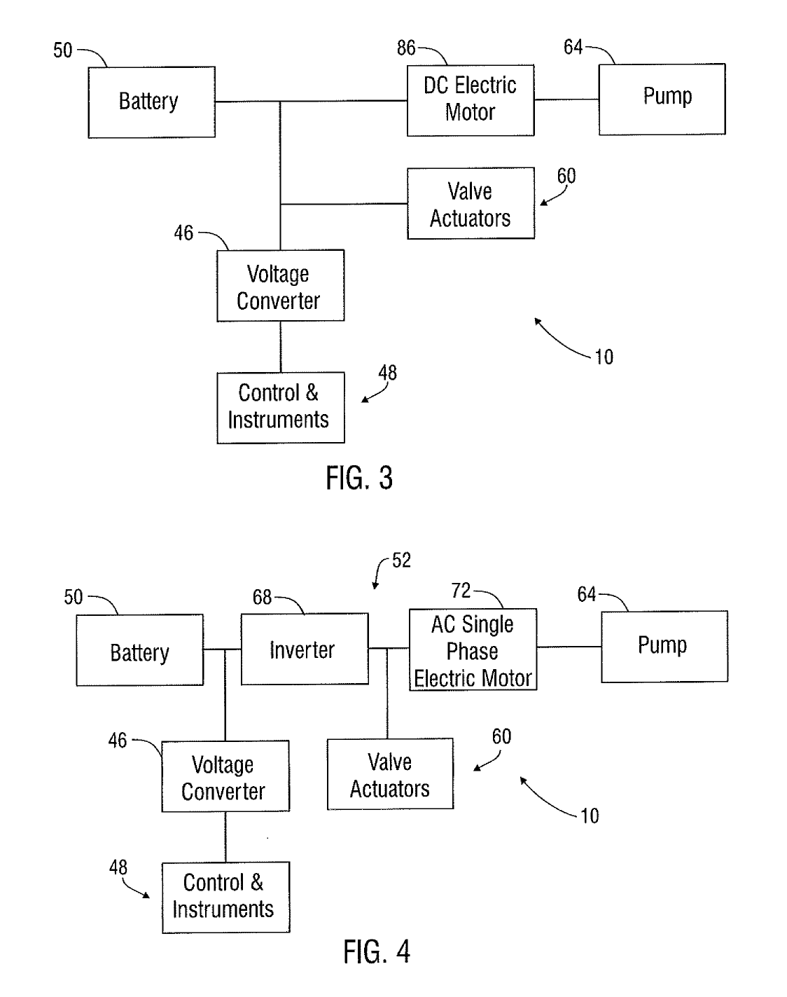

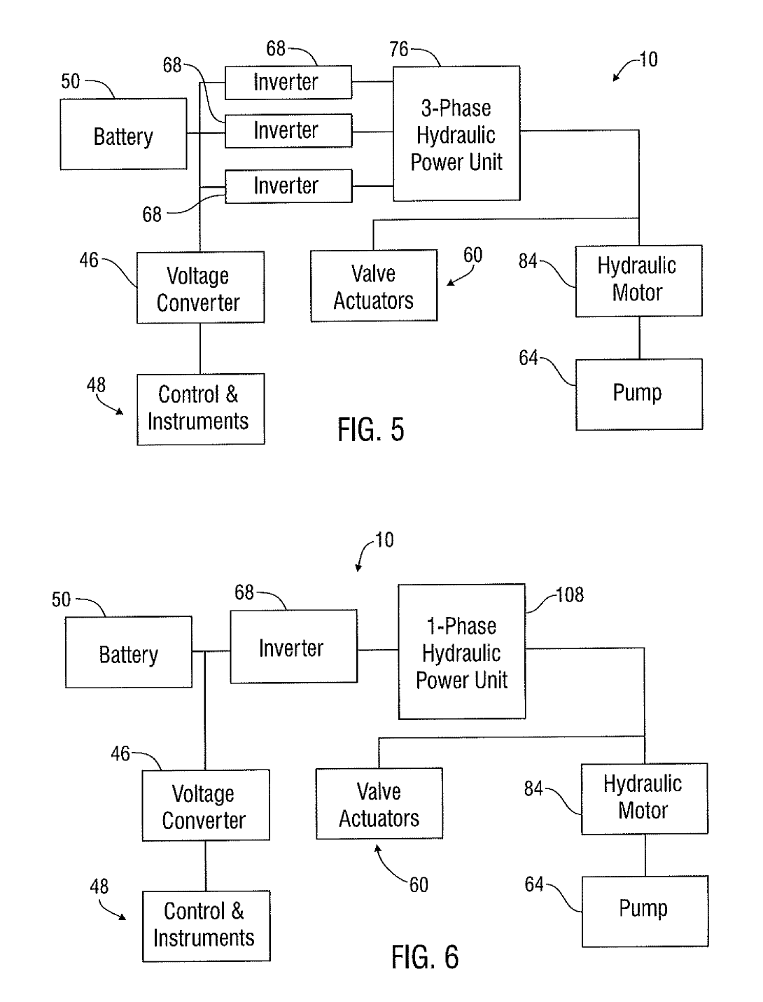

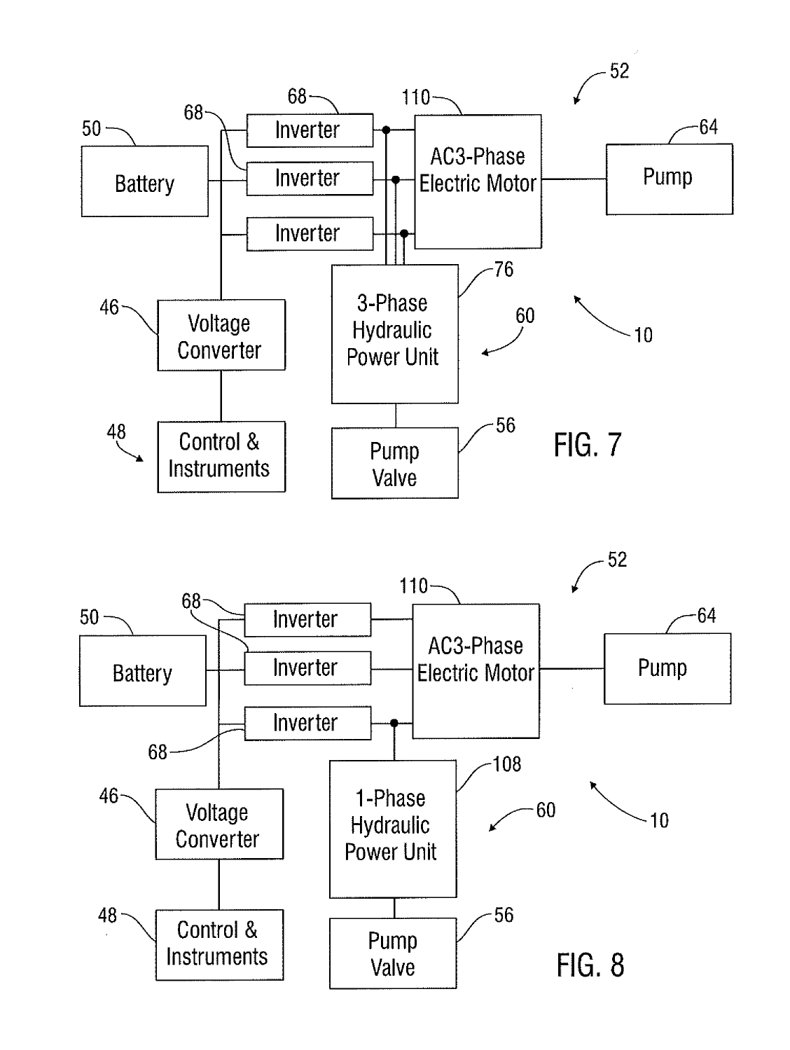

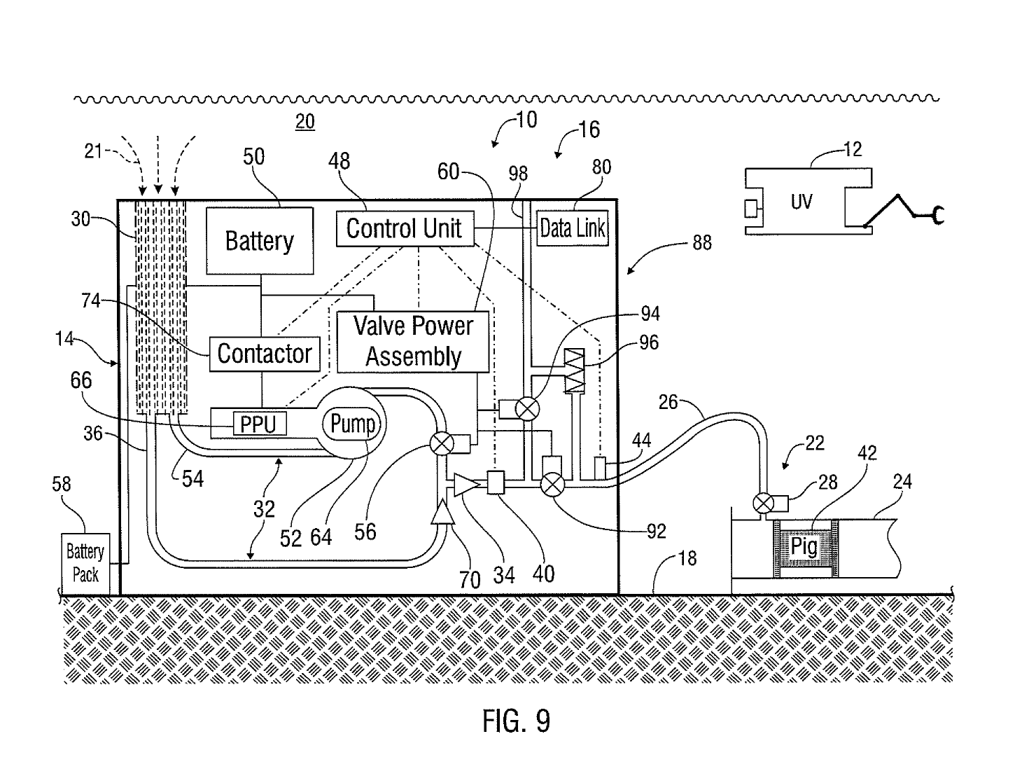

Various other potential power supply arrangements, which may be used in the subsea pipeline servicing system 10 of FIG. 1 or other similar systems, are shown in FIGS. 3-8. In FIG. 3, DC battery power is supplied directly to the valve power assembly 60 and to a DC electric motor 86, which drives the fluid pump 64. Battery power is provided through a voltage converter 46 to the control unit 48 and related instruments which may be included in the system 10, such as a data logger and subsea display (not shown) and the data link 80, flow meter 40 and pressure sensor 44 (FIG. 1). In FIG. 4, power is provided from one or more inverters 68 to a single phase AC electric motor 72, which drives the pump 64. In FIG. 5, power is provided through one or more inverters 68 and a 3-phase AC hydraulic power unit 76 to the valve power assembly 60 and to a hydraulic motor 84, which drives the fluid pump 64. FIG. 6 illustrates an embodiment in which power is provided through a single phase AC hydraulic power unit 108 to the valve power assembly 60 and to a hydraulic motor 84 that drives the fluid pump 64. In FIG. 7, power is provided through one or more inverters 68 to (i) a 3-phase AC hydraulic power unit 76 in the valve power assembly 60 to power the pump valve 56, and (ii) a 3-phase AC electric motor 110 to drive the fluid pump 64. In FIG. 8, a single phase AC hydraulic power unit 108 is used in the valve power assembly 60. It should be understood that the system 10 is not limited to use with the example power arrangements disclosed herein. Any other suitable power arrangement may be included. Moreover, if additional stand-alone batteries 58 (e.g. FIG. 9) are used, they may be connected to provide power in addition to, or in place of the battery 50 in any of the power arrangements mentioned herein or which otherwise may be used.

Referring back to FIG. 1, a second non-return valve 70 is included in this embodiment to prevent flow back through the pump bypass line 36 and inlet filter 30, such as when the pump assembly 52 is pumping fluid into the jumper 26 from the pump line 54. The non-return valve 70 may have any suitable configuration, construction and operation. For example, it may be a shut-off, or flooding, valve and may have an actuator, such as an electrically or hydraulically powered actuator.

It is often required to treat water entering the pipeline 24 by the addition of liquids, such as chemicals used to reduce corrosion in the pipeline 24. If desired, one or more liquid injectors and reservoirs (not shown) may be included in the skid frame 14. The liquid injector(s) would be in fluid communication with the piping 32 so that the desired chemicals or other liquids could be injected into the fluid flow transmitted into the pipeline 24 from the system 10. If desired, the reservoir may contain mixed liquids, or multiple reservoirs may be used for the same or different liquids. Any suitable technology for injecting the liquid may be used. Some examples are (i) a venturi providing reduced pressure and drawing the liquid from the reservoir and (ii) one or more pumps powered by any of the power sources available in the system 10.

In the embodiment of FIG. 1, the battery 50 is configured to provide electrical power for autonomous operation of the subsea pipeline servicing system 10. The battery 50 may include any suitable battery technology, as is or becomes further known. For example, the battery 50 may be rechargeable, include suitable underwater packaging and pressure-resistant or pressure-compensated housings. When a rechargeable battery is used, an underwater vehicle (UV) 12 may be used to temporarily connect an electrical supply underwater to recharge the battery. The connection may, for example, include a wet mateable electrical connector or an inductive coupling, and the electrical supply may be from the UV 12 umbilical or tether, or may be from a separate line. In other embodiments, the battery 50 may be rechargeable from the surface, such as via an umbilical from a marine vessel or fixed installation. As used herein and in the appended claims, the term underwater vehicle (UV) means and includes a remotely operated vehicle (ROV), an autonomous underwater vehicle (AUV) as are and become further known, any other unmanned or manned vehicle, such as a mini-submarine, or any other device that can be deployed underwater and engage or interact with the system 10 or skid 14.

In some embodiments, the battery 50 may not be disposed on the skid frame 14, but instead provided in a separate unit deployed to the sea floor 18 or otherwise proximate to the skid frame 14 and electrically connected with the system 10. In yet other embodiments, one or more stand-alone batteries 58 (e.g. FIG. 9) may be deployed to the sea floor 18 and electrically connected with the system 10 (e.g. by a UV 12), such as to augment, supplement or increase the power supply of the system 10. If desired, multiple stand-alone batteries 58 may be alternatively deployed, retrieved, recharged (e.g. from a UV, marine vessel or fixed installation) and re-deployed, such as to provide continuous power to the system 10.

Still referring to the embodiment of FIG. 1, the system 10 may include one or more contactor 74. In this example, the contactor 74 is a high-power switch for connecting the battery 50 to the pump assembly 52 and is controlled by the control unit 48.

Electrical equipment (e.g. motors, inverters) that may be included in the system 10 will typically generate heat during their operation. Depending upon the temperature of the sea water 20 and duration of operation of the system 10, some generation of heat may be acceptable. At other times, cooling of various components on the system 10 may be necessary or desired. Any suitable technique and equipment for cooling may be used. For example, one or more impellers (not shown) powered by any of the power sources on the system 10 may be used to move water over the outside of the component housings (not shown). For another example, one or more portion of the piping 32 may be configured so that its passes through enclosures around particular components that will be cooled when sea water flows through the piping 32.

Now referring to FIG. 9, the subsea pipeline servicing system 10 may also be useful for hydrotesting the pipeline 24. In the illustrated embodiment, the pump assembly 52 is capable of serving as both a boost pump for flooding operations and also a high pressure pump for hydrotesting the pipeline 24. In this example, the pump assembly 52 may, if desired, include a variable speed pump power unit 66. The illustrated system 10 includes a pressure relief manifold 88 having a double block valve 92, discharge valve 94, pressure relief valve 96 and discharge piping 98. The valves 92, 94 and 96 may have any suitable configuration and operation. In this embodiment, the valves 92 and 94 are controlled by the valve power assembly 60 in response to signals from the control unit 48, similarly as described above with respect to the pump valve 56. The exemplary double block valve 92 may be used, for example, to serve as a second (or third) barrier in the piping 32 in combination with one or more other valve (e.g. valves 34, 56, 70 and 94) for preventing unwanted backflow from the pipeline 24. The double block valve 92 and discharge valve 94 of this embodiment may be used, for example, to release pressure through the discharge piping 98 (which opens to the sea), such as at the end of a hydrotest or if an operation is abandoned (e.g. due to one or more leaks). The pressure relief valve 96 of this embodiment may be used, for example, to ensure that the maximum allowable pressure in the pipeline 24 is not exceeded, such as when pressure variations occur during hydrotesting due to ambient temperature changes or other events/variables, or in the event of failure of the control unit 48.

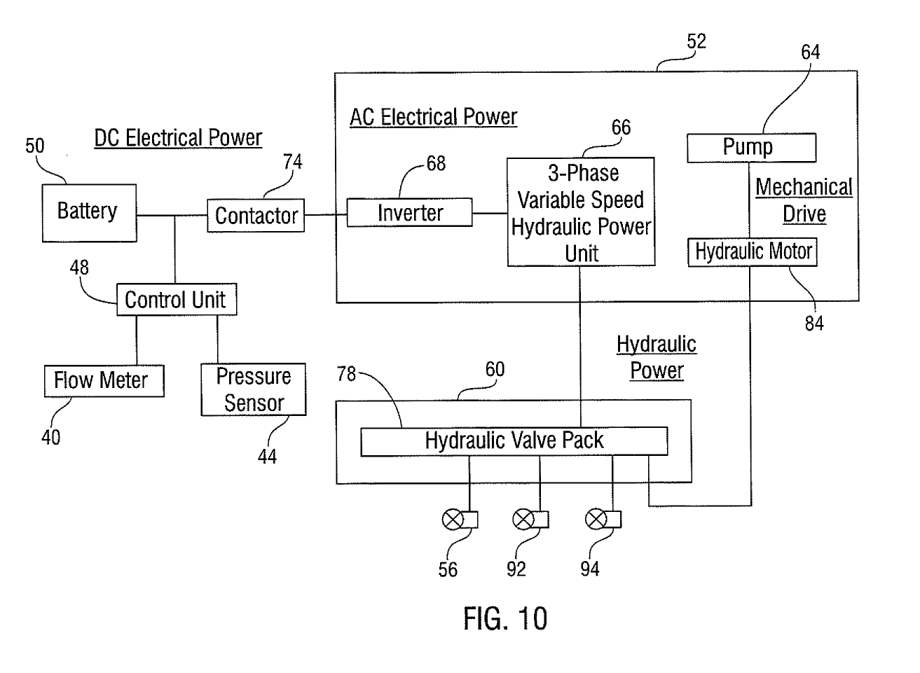

FIG. 10 illustrates one potential power supply arrangement for a subsea pipeline servicing system 10 which includes a pressure relief manifold 88, such as the system 10 of FIG. 9. In this example, the pump power unit 66 of the pump assembly 52 is a 3-phase variable speed hydraulic power unit, which supplies power to a hydraulic valve pack 78 in the valve power assembly 60. The hydraulic valve pack 78 switches power to the pump valve 56, double block valve 92 and discharge valve 94, and also to a hydraulic motor 84 in the pump assembly 52, which mechanically drives the fluid pump 64. However, any other suitable power arrangements may be used.

In other embodiments, such as the example of FIG. 11, the system 10 may be configured for hydrotesting only. The illustrated fluid pump 64 is a high pressure pump. A pump bypass line (e.g. item 36, FIG. 9) and a second non-return valve (e.g. item 70, FIG. 9) are not included. For pipeline flooding operations, a separate subsea pipeline servicing system, such as the system 10 of FIG. 1, could be used.

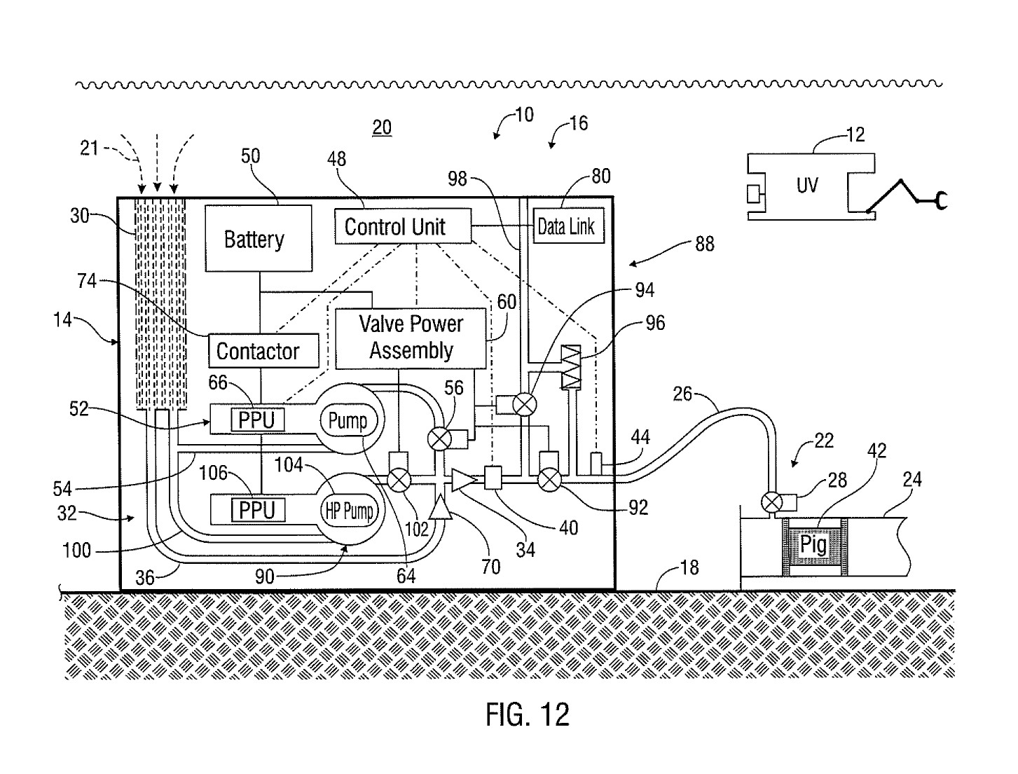

In yet other embodiments, such as the example of FIG. 12, the system 10 may be configured with both the pump assembly 52 for flooding of the pipeline 24 and a high-pressure (HP) pump assembly 90 for hydrotesting. In this embodiment, a HP pump valve 102 is included and configured to allow or disallow fluid flow from the fluid pump 64 through the piping 32 to the jumper 26, isolate the HP fluid pump 104 when not in use and prevent undesired fluid flow through or into the pump 104 and/or HP pump line 100. The HP pump valve 102 may have any suitable configuration and operation. For example, the HP pump valve 102 may be controlled by the valve power assembly 60 based upon signals from the control unit 48, similarly as described above for other valves 56, 92 and 94.

The HP pump assembly 90 may have any suitable configuration and operation. In this example, the HP pump assembly 90 includes a HP fluid pump 104 and HP pump power unit 106. The illustrated HP fluid pump 104 is fluidly connected to a HP pump line 100, which fluidly communicates between the inlet filter 30 and the jumper 26. The HP fluid pump 104 may be powered similarly as described above with respect to the fluid pump 64 or any other suitable arrangement.

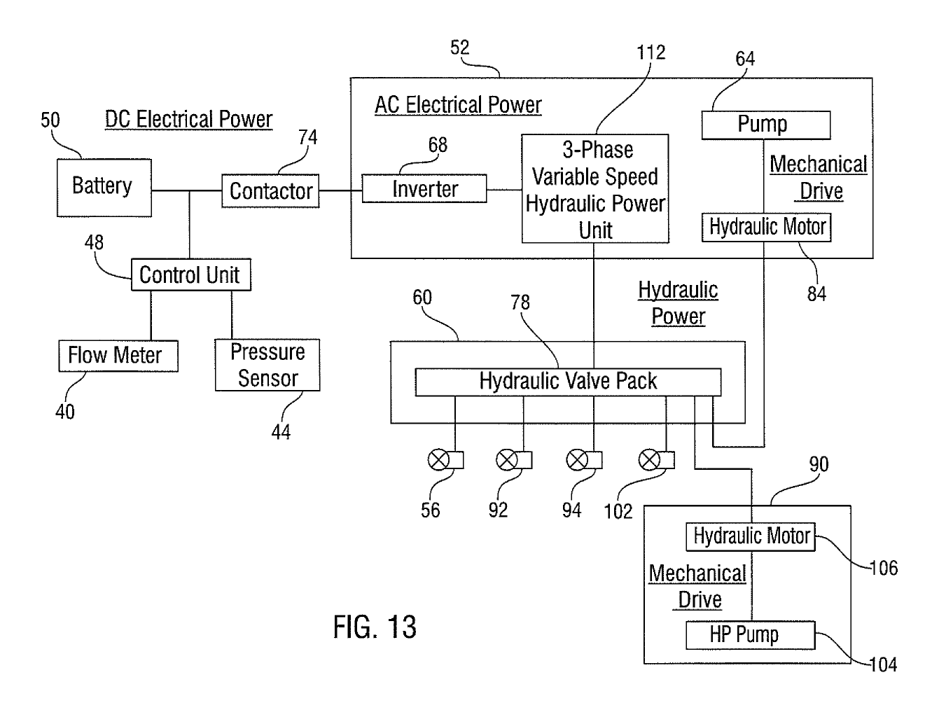

An example power arrangement for a system including a pump assembly 52 and HP pump assembly 90 is shown in FIG. 13. In this embodiment, the pump 64, HP pump 104 and valves 56, 92, 94 and 102 are hydraulically powered from a single 3-phase variable speed hydraulic power unit 112 and 3-phase inverter 68. The exemplary valve power assembly 60 has a hydraulic valve pack 78 that switches hydraulic power from the pump power unit 66 to the valves 56, 92, 94 and 102 and pumps 64 and 104, as required. If desired, the control unit 48 can vary the speed of the HP pump 104 by varying the speed of the 3-phase variable speed hydraulic power unit 112, such as to achieve the desired or required flow. In other embodiments, contactors may be used for switching each pump 64, 104.

It may be desirable to provide flow variability or regulation for the pumps in the subsea pipeline servicing system 10. For example, when approaching the test pressure during hydrotesting, it may be desirable to use the pump(s) to reduce the fluid flow rate to control the risk of overpressure. Any suitable techniques and components using one or more pumps in the system 10 for flow regulation may be included. It should be noted that the particular flow regulation technique used may depend upon the circumstances of the particular application, such as pressure changes during the hydrotest, flow ranges for different pipeline sizes and/or the power limits of the system 10.

For example, the pump assembly 52 and/or HP pump assembly 90 may provide variable speed drive and pump capabilities. Any suitable variable speed drive arrangement may be used and controlled in any suitable manner. For example, variable pump speeds may be operated by signals from the control unit 48. Some examples of potential variable speed drive arrangements are (i) a chopper circuit with a DC submersible electric motor, (ii) a variable frequency drive inverter with a 3-phase AC submersible electric motor, (iii) either submersible electric motor of (i) or (ii) driving a hydraulic power unit, which drives a hydraulic motor, (iv) a fixed-speed AC or DC submersible motor driving a hydraulic power unit with a swash plate to vary the delivered hydraulic flow, which drives a hydraulic motor.

Referring back to FIG. 1, the exemplary control unit 48 includes one or more computer that monitors and records data from the flow meter(s) 40 and pressure sensor(s) 44 and controls functioning of the pump valve 56 and pump assembly 52 in accordance with programmable logic. If desired, the control unit 48 could be programmed to control operation of other components on the skid frame 14 or the pipeline valve 28. Also, the control unit 48 may record any additional data as desired, such as battery voltage data, temperature data, conduit integrity data, electrical and power connection data, etc.

The illustrated control unit 48 may obtain power from any suitable source, such as the battery 50 or another battery dedicated to the control unit 48 via a voltage converter. In this embodiment, the control unit 48 supplies power to the flow meter 40 and pressure sensor 44 and records data. In other embodiments, the flow meter 40 may not require power from the control unit 48 or battery 50. If desired, the control unit 48 may include a subsea display to show information, such as the status of the system 10 before, during and/or after operations.

Still referring to the embodiment of FIG. 1, the exemplary control unit 48 is configured to communicate with one or more external sources through one or more data link 80. If desired, the system 10 may be configured so that data (e.g. commands) may also be transmitted from the external source(s) to the control unit 48. The data link 80 may have any suitable configuration and operation. Any suitable mechanism for data transmission to or from the control unit 48 or data link 80 may be used, such as (i) one or more wet mateable electrical connector, (ii) inductive coupling, (iii) acoustic transmission through the sea water 20, (iv) optical transmission through the sea water 20 and (iv) radio, or wireless, transmission through the sea water 20. In this embodiment, the data link 80 is a radio frequency data transmitter configured to transmit data from the control unit 48 to any desired external source (e.g. UV 12, marine vessel, fixed installation, etc.). Short range transmission between the data link 80 and UV 12 may be preferred, such as to assist in minimizing ambient noise, other interference and signal reflection that may decrease transmission effectiveness or accuracy. However, some embodiments may not include a data link 80.

The system 10 may be configured so that data link 80 is useful for any desired purpose in connection with flooding and/or hydrotesting operations. For example, the data record for the flooding and/or hydrotesting operations may be transmitted to one or more external source via the data link 80. In some embodiments, the data record may be retrievable while the skid frame 14 is deployed on the sea bed 18 or after the skid frame 14 is returned to surface from its temporary subsea location. When the data link 80 is used during hydrotesting, for example, the engineer in charge (or other personnel) may periodically use data received through the data line 80 to check the status or review the progress of the hydrotesting operations and/or initiate the next stage. For another example, when increasing pressure during hydrotesting, it may be desirable to pause at intermediate pressures to ensure the operation is progressing as expected and no leaks in the pipeline 24 are detected. In such instances, the control unit 48 can be programmed not to initiate the pump 52 (FIGS. 3 and 5) or HP pump 104 (FIG. 6) for a “next stage” pressure increase until it receives a command through the data link 80. For yet another example, at the end of a hydrotest, the data link 80 may be used to provide commands to release the pipeline pressure. For still a further example, one or more external source may have the capability to override operation of the control unit 48 via the data link 80, such as during an emergency or unplanned event.

All components of the aforementioned embodiments of the system 10 are connected by suitable piping and cabling. Electrical equipment may be housed in pressure-resistant or pressure-compensated housings, as necessary.

An embodiment method of use of the exemplary subsea pipeline servicing system 10 of FIG. 1 will now be described. The skid frame 14 is delivered to the desired temporary site on the sea floor 18 and the jumper 26 is connected with the pipeline 24, such as by the UV 12 or other suitable manner. The UV 12 can also be used to actuate the control unit 48 and open (and later close) the pipeline valve 28, In other embodiments, the control unit 48 may be deployed in an “on” state, or could be activated wirelessly or with another suitable technique. Also, the opening (and later closing) of the pipeline valve 24 could instead be controlled by the control unit 48 without the use of a UV 12. In many applications, the UV 12 may not otherwise be necessary during flooding and/or hydrotesting of the pipeline 24.

If desired, when operation of the control unit 48 is initiated, the pump valve 56 may be in an open position to allow free flooding of all piping 32. If so, the exemplary control unit 48 thereafter closes the pump valve 56 to configure the system for initial flooding by natural underwater pressure.

In this embodiment, to flood the pipeline 24, sea water 20 flows through or past the inlet filter 30, pump bypass line 36, flow meter 40, non-return valves 70, 34, pressure sensor 44, jumper 26 and pipeline valve 28, and then flows into the pipeline 24. As the pipeline 24 behind the pig or pig train 42 is filled with water, the pig or pig train 42 moves along the pipeline 24. The exemplary control unit 48 monitors the flow rate of the water 20 passing into the pipeline 24 based upon signals from the flow meter 40. The water 20 is allowed to flow naturally into the pipeline 24 due to the prevailing hydrostatic pressure until the flow stops or reduces to an undesirable rate.

Still referring to the embodiment of FIG. 1, when the pig 42 approaches the distant end of the pipeline 24, based upon the flow rate or at any other desired time, the control unit 48 initiates the fluid pump 64 for use as a “boost pump”. In this example, the control unit 48 sends signals to the valve power assembly 60 to open the pump valve 56 and to the pump assembly 52 to turn on the fluid pump 64. The fluid pump 64 then pumps water 20 (entering the system 10 through the inlet filter 30) from the pump line 54, into the jumper 26 and pipeline 24. If desired, the control unit 48 continues to monitor water flow and/or pressure. If the speed of the fluid pump 64 is variable, the control unit 48 may also control or vary the pump speed as deemed necessary. At a desired time thereafter, such as when the pig 42 has reached the distant end of the pipeline 24, the control unit 48 sends commands to turn off the fluid pump 64 and may also close the pump valve 56. Depending upon the programming of the control unit 48, at any desired time during the above operations, the control unit 48 may record flow rates and any other desired data and, via the data link 80, transmit data to one or more external source, or receive commands therefrom.

When the subsea pipeline servicing system 10 is thereafter used to hydrotest the pipeline 24, the exemplary method of operation includes additional actions. If the embodiment of FIG. 9 is used, for example, the pump assembly 52 includes a variable speed pump power unit 66 capable of both flooding and hydrotesting the pipeline 24. After completing flooding with this embodiment, the exemplary control unit 48 will go into a hold mode until the passage of a certain time span or upon receiving a command (e.g. from the surface or other external source through the data line 80) to open the pump valve 56 (if it was previously closed) and actuate the pump power unit 66 to turn on the pump 64. This delay allows preparation for hydrotesting, such as closing one or more valves (not shown) on the pipeline 24, removing the pig 42 or other desired actions.

Thereafter, fluid pressure in the pipeline 24 may be progressively raised during multiple stages using the autonomous power and control of the system 10. Alternatively, each pressure stage may be initiated by external command via the data link 80, such as when an operator desires to control the timing of each stage to assess leaks or for another purpose. The maximum required hydrotest pressure may be held for any desired period, such as eight hours or more or less, depending upon the design standards of the pipeline 24. If desired, the control unit 48 may be programmed so that external monitoring is not necessary during the hold period. When the pipeline pressure has been increased sufficiently for a hydrotest, the pump 64 is stopped and the pump valve 56 closed, such as to assist in holding the pressure in the line ahead of the valve 66 and prevent back pressure into the pump assembly 52. At the end of the hydrotest, the exemplary double block valve 92 and discharge valve 94 may be used, if necessary, to release pressure through the discharge piping 98. Once the pressure is reduced to an acceptable level, the pipeline valve 28 may be closed to assist in preventing unwanted backflow from the pipeline 24.

Preferred embodiments of the present disclosure thus offer advantages over the prior art and are well adapted to carry out one or more of the objects of this disclosure. However, the present invention does not require each of the components and acts described above and is in no way limited to the above-described embodiments or methods of operation. Any one or more of the above components, features and processes may be employed in any suitable configuration without inclusion of other such components, features and processes. Moreover, the present invention includes additional features, capabilities, functions, methods, uses and applications that have not been specifically addressed herein but are, or will become, apparent from the description herein, the appended drawings and claims.

The methods that may be described above or claimed herein and any other methods which may fall within the scope of the appended claims can be performed in any desired suitable order and are not necessarily limited to any sequence described herein or as may be listed in the appended claims. Further, the methods of the present invention do not necessarily require use of the particular embodiments shown and described herein, but are equally applicable with any other suitable structure, form and configuration of components.

While exemplary embodiments of the invention have been shown and described, many variations, modifications and/or changes of the system, apparatus and methods of the present invention, such as in the components, details of construction and operation, arrangement of parts and/or methods of use, are possible, contemplated by the patent applicant(s), within the scope of the appended claims, and may be made and used by one of ordinary skill in the art without departing from the spirit or teachings of the invention and scope of appended claims. Thus, all matter herein set forth or shown in the accompanying drawings should be interpreted as illustrative, and the scope of the disclosure and the appended claims should not be limited to the embodiments described and shown herein.

1. Apparatus for filling and/or flooding a subsea pipeline, the apparatus comprising:
a submersible skid configured to be deployed to the vicinity of the pipeline;
at least one fluid conduit disposed at least partially upon said skid and fluidly engageable with the pipeline;
at least one pump mounted on said skid, said at least one pump configured to pump fluid through said fluid conduit into the pipeline for at least one among filling and flooding the pipeline;
at least one pump valve disposed upon said skid and associated with said pump;
at least one fluid flow meter configured to measure the fluid flow rate in said fluid conduit;
at least one control unit disposed upon said skid and configured to control the operation of said pump and said pump valve, receive data from said fluid flow meter, and actuate at least one said pump valve and pump at least partially based upon data from said fluid flow meter; and
at least one battery associated with said skid and configured to provide sufficient power to said pump and said control unit for performing at least one among filling and flooding of the subsea pipeline without power being provided to said skid from an underwater vehicle or through a cable from the surface.

2. The apparatus of claim 1 wherein said control unit is configured to autonomously control the operation of said pump and said pump valve for at least one among filling and flooding the pipeline without involvement of an underwater vehicle or other external control source for controlling operations on the skid necessary for filling or flooding the pipeline.

3. The apparatus of claim 2 wherein said at least one battery includes at least a first battery disposed on said skid and at least a second battery disposed on the sea floor proximate to said skid, said second battery being configured to provide power to said skid without connection to an underwater vehicle or cable extending to the surface.

4. The apparatus of claim 3 wherein at least one among said first and second batteries is configured to be rechargeable via connection to an underwater vehicle.

5. The apparatus of claim 1 wherein said control unit is configured to gather and store data, further including at least one data link providing communication between said control unit and at least one external source, said data link configured to allow the transmission of data between said control unit and said external source.

6. The apparatus of claim 5 wherein said control unit is configured so that its control of the operation of said pump and said pump valve may be overridden by commands received through said data link.

7. The apparatus of claim 1 further including a pump power unit engaged between said battery and said pump and configured to actuate said pump based upon commands from said control unit, and a valve power assembly engaged between said battery and said pump valve and configured to actuate said pump valve based upon commands from said control unit.

8. The apparatus of claim 7 wherein said valve power assembly includes a hydraulic power unit configured to provide power to said pump valve, and wherein said pump power unit is an electric motor configured to provide power to said pump, further including at least one inverter engaged between said battery and (i) said electric motor and (ii) said hydraulic power unit, said inverter being configured to provide power to said hydraulic power unit and said electric motor.

9. Apparatus for filling and/or flooding a subsea pipeline, the apparatus comprising:
a submersible skid configured to be deployed to the vicinity of the pipeline;
at least one fluid conduit disposed at least partially upon said skid and fluidly engageable with the pipeline;
at least one pump mounted on said skid, said pump configured to pump fluid through said fluid conduit into the pipeline for at least one among filling and flooding the pipeline;
at least one pump valve disposed upon said skid and associated with at least one said pump;
at least one fluid flow meter configured to measure the fluid flow rate in said fluid conduit;
at least one control unit disposed upon said skid and configured to control the operation of said pump and said pump valve, receive data from said fluid flow meter and actuate said pump and said pump valve based at least partially upon data from said fluid flow meter; and
at least one battery disposed upon said skid and configured to provide sufficient power to said pump and said control unit for performing at least one among filling and flooding of the pipeline without power being provided to said skid from an underwater vehicle or other external source.

10. The apparatus of claim 9 further including at least one inverter and at least one hydraulic power unit configured to provide power to said pump and said pump valve.

11. The apparatus of claim 10 wherein said at least one hydraulic power unit is a variable speed hydraulic power unit.

12. The apparatus of claim 9 wherein said control unit is configured to autonomously control the operation of said pump and said pump valve for at least one among filling and flooding the pipeline without involvement of an underwater vehicle or other external control source for controlling operations on the skid necessary for filling or flooding the pipeline.

13. The apparatus of claim 12 wherein said at least one battery is configured to be rechargeable via connection to an underwater vehicle.

14. The apparatus of claim 12 wherein said control unit is configured to gather and store data further including at least one data link providing communication between said control unit and at least one external source, said data link configured to allow the transmission of data between said control unit and said external source.

15. Apparatus for hydrotesting a subsea pipeline, the apparatus comprising:
a submersible skid configured to be deployed to the vicinity of the pipeline;
at least one fluid conduit disposed at least partially upon said skid and fluidly engageable with the pipeline;
at least one pump mounted on said skid, said at least one pump configured to pump fluid through said fluid conduit into the pipeline for hydrotesting the pipeline;
at least one pump valve disposed upon said skid and associated with said pump;
at least one pressure sensor configured to measure the pressure of fluid flowing into the pipeline from said fluid conduit;
at least one control unit disposed upon said skid and configured to receive data from said pressure sensor and control the operation of said pump and said pump valve; and
at least one battery associated with said skid and configured to provide sufficient power to said pump and said control unit for performing hydrotesting of the pipeline without power being provided to said skid from an underwater vehicle or through a cable from the surface.

16. The apparatus of claim 15 wherein said control unit is configured to autonomously control the operation of said pump and said pump valve for hydrotesting the pipeline without involvement of an underwater vehicle or other external control source for controlling operations on the skid necessary for hydrotesting.

17. The apparatus of claim 16 wherein said at least one battery includes at least a first battery disposed on said skid and at least a second battery disposed on the sea floor proximate to said skid, said second battery being configured to provide power to said skid without connection to an underwater vehicle or cable extending to the surface.

18. The apparatus of claim 16 wherein said control unit is configured to gather and store data, further including at least one data link providing communication between said control unit and at least one external source, said data link configured to allow the transmission of data between said control unit and said external source.

19. The apparatus of claim 18 further including a pump power unit engaged between said battery and said pump and configured to actuate said pump based upon commands from said control unit, and a valve power assembly engaged between said battery and said pump valve and configured to actuate said pump valve based upon commands from said control unit.

20. The apparatus of claim 19 wherein said valve power assembly includes a hydraulic power unit configured to provide power to said pump valve, and wherein said pump power unit is an electric motor configured to provide power to said pump, further including at least one inverter engaged between said battery and (1) said electric motor and (ii) said hydraulic power unit, said inverter being configured to provide power to said hydraulic power unit and said electric motor.

21. Apparatus for hydrotesting a subsea pipeline, the apparatus comprising:
a submersible skid configured to be deployed to the vicinity of the pipeline;
at least one fluid conduit disposed at least partially upon said skid and fluidly engageable with the pipeline;
at least one pump mounted on said skid, said pump configured to pump fluid through said fluid conduit into the pipeline for hydrotesting the pipeline;
at least one pump valve disposed upon said skid and associated with at least one said pump;
at least one pressure sensor configured to measure the pressure of fluid flowing into the pipeline from said fluid conduit;
at least one control unit disposed upon said skid and configured to receive data from said pressure sensor and control the operation of said pump and said pump valve; and
at least one battery disposed upon said skid and configured to provide sufficient power to said pump and said control unit for performing hydrotesting of the subsea pipeline without power being provided to said skid from an underwater vehicle or other external source.

22. The apparatus of claim 21 wherein said control unit is configured to autonomously control the operation of said pump and said pump valve for hydrotesting the pipeline without involvement of an underwater vehicle or other external control source for controlling operations on the skid necessary for hydrotesting.

23. The apparatus of claim 22 wherein said control unit is configured to gather and store data, further including at least one data link providing communication between said control unit and at least one external source, said data link configured to allow the transmission of data between said control unit and said external source.

24. The apparatus of claim 23 further including a pump power unit engaged between said battery and said pump and configured to actuate said pump based upon commands from said control unit, and a valve power assembly engaged between said battery and said pump valve and configured to actuate said pump valve based upon commands from said control unit.

25. Apparatus for autonomously controlling at least one among filling, flooding and hydrotesting a subsea pipeline, the apparatus comprising:
a submersible skid configured to be deployed to the vicinity of the pipeline;
at least one fluid conduit disposed at least partially upon said skid and fluidly engageable with the pipeline;
at least one pump mounted on said skid, said pump configured to pump fluid through said fluid conduit into the pipeline for at least one among filling, flooding and hydrotesting the pipeline;
at least one pump valve disposed upon said skid and associated with said pump;
at least one control unit disposed upon said skid and configured to autonomously control operation of said pump valve and said pump necessary for performing at least one among filling, flooding and hydrotesting of the pipeline without involvement of an underwater vehicle or other external source for controlling functions on the skid relating thereto.

26. The apparatus of claim 25 further including at least one battery associated with said skid and configured to provide sufficient power to said pump and said control unit for performing at least one among filling, flooding and hydrotesting of the subsea pipeline without power being provided to said skid from an underwater vehicle or power source at the surface.

27. The apparatus of claim 26 wherein said battery is disposed upon said skid and configured to be rechargeable by connection to an underwater vehicle.

28. The apparatus of claim 26 wherein said at least one battery includes a first battery disposed upon said skid and a second battery disposed on the sea bed proximate to said skid.

29. The apparatus of claim 25 wherein said control unit is configured to gather and store data, further including at least one data link providing communication between said control unit and at least one external source, said data link configured to allow the transmission of data between said control unit and said external source.

30. The apparatus of claim 29 wherein said control unit is configured so that its control of the operation of said pump and said pump valve may be overridden by commands received through said data link.

31. The apparatus of claim 29 further including at least one among at least one pressure sensor configured to measure the pressure of fluid flowing into the pipeline from said fluid conduit and at least one fluid flow meter configured to measure the fluid flow rate in said fluid conduit, wherein said control unit is configured to receive data from at least one among said fluid flow meter and said pressure sensor and actuate said pump and said pump valve based at least partially upon such data.

32. A method of flooding a subsea pipeline having at least one pig disposed therein with the use of a deployable skid and at least one battery associated with the skid and not connected to an underwater vehicle or cable extending to the surface, the skid including a control unit, a fluid conduit connectable with the pipeline and at least one pump, pump valve and flow meter associated with the fluid conduit, the method comprising:
lowering the skid to the sea bed;
fluidly connecting the fluid conduit to the pipeline;
turning on the control unit and ensuring the pump valve is closed;
opening a pipeline valve associated with the pipeline;
allowing the natural flow of sea water through the fluid conduit into the pipeline;
the control unit monitoring the flow rate in the fluid conduit via the flow meter;
the control unit opening the pump valve and turning on the pump;
the pump valve allowing the flow of fluid from the pump into the fluid conduit;
the pump pumping fluid through the fluid conduit into the pipeline;
the control unit turning off the pump based upon one or more among the flow rate in the fluid conduit, the passage of a certain duration of time or when the pig reaches the distant end of the pipeline; and
the at least one battery providing sufficient power to the pump and control unit for flooding the pipeline, whereby power to the skid from an underwater vehicle or cable to the surface is not required for flooding the pipeline.

33. The method of claim 32 further including the control unit autonomously controlling all operations on the skid relating to flooding the pipeline without involvement of an underwater vehicle or other external control source for controlling operations on the skid necessary for flooding the pipeline.

34. The method of claim 33 wherein the control unit opens the pump valve and turns on the pump based upon the flow rate in the fluid conduit.

35. The method of claim 32 further including the at least one external source overriding the control unit in controlling at least one operation on the skid, and the external source providing commands to the skid.

36. The method of claim 32 further including
the control unit gathering and storing data, and
at least one data link on the skid providing communication between the control unit and at least one external source and allowing the transmission of data between the control unit and the external source.

37. The method of claim 36 further including
at least one pressure sensor on the skid measuring the pressure of fluid flowing into the pipeline from the fluid conduit,
the control unit monitoring the pressure in the fluid conduit via the pressure sensor,
the control unit, after a certain duration of time or based upon a signal received from an external source through the data link, opening a high pressure pump valve on the skid and turning on a high pressure pump on the skid to pump fluid through the fluid conduit into the pipeline for hydrotesting the pipeline, and
the control unit turning off the high pressure pump after a certain duration of time or when the pressure is at or above a certain level.

38. The method of claim 32 wherein the at least one battery is disposed on the skid, further including connecting an underwater vehicle to the battery to recharge the battery.

39. The method of claim 32 further including
deploying a replaceable battery to the sea floor and connecting the replaceable battery to the skid for providing power to the skid,
disconnecting the replaceable battery from the skid and retrieving it to the surface, and
deploying another replaceable battery to the sea floor and connecting it to the skid.

40. A method of flooding a subsea pipeline having at least one pig disposed therein with the use of a deployable skid including a control unit, at least one battery, a fluid conduit connectable with the pipeline and at least one pump, pump valve and fluid flow meter associated with the fluid conduit, the pump valve allowing the flow of fluid from the pump into the fluid conduit, the method comprising:
lowering the skid to the sea bed;
fluidly connecting the fluid conduit to the pipeline;
turning on the control unit and ensuring the pump valve is closed;
opening a pipeline valve associated with the pipeline;
allowing the natural flow of sea water through the fluid conduit into the pipeline;
the control unit monitoring the flow rate in the fluid conduit via the flow meter;
the control unit opening the pump valve and turning on the pump based upon the flow rate in the fluid conduit;
the pump pumping fluid through the fluid conduit into the pipeline;
the control unit turning off the pump based upon one or more among the flow rate in the fluid conduit, the passage of a certain duration of time and when the pig reaches the distant end of the pipeline; and
the at least one battery on the skid providing sufficient power to the pump and control unit for flooding the pipeline, whereby flooding the subsea pipeline is powered autonomously without power provided to the skid from an underwater vehicle or other external source.

41. The method of claim 40 further including the control unit autonomously controlling all operations on the skid relating to flooding the pipeline without involvement of an underwater vehicle or other external control source for controlling operations on the skid necessary for flooding the pipeline.

42. The method of claim 41 further including
the control unit gathering and storing data, and
at least one data link on the skid providing communication between the control unit and at least one external source and allowing the transmission of data between the control unit and the external source.

43. The method of claim 42 further including
at least one pressure sensor on the skid measuring the pressure of fluid flowing into the pipeline from the fluid conduit,
the control unit monitoring the pressure in the fluid conduit via the pressure sensor,
the control unit, after a certain duration of time or based upon a signal received from an external source through the data link, opening a high pressure pump valve on the skid and turning on a high pressure pump on the skid to pump fluid through the fluid conduit into the pipeline for hydrotesting the pipeline, and
the control unit turning off the high pressure pump after a certain duration of time or when the pressure is at or above a certain level.

44. The method of claim 43 further including connecting an underwater vehicle to the battery to recharge the battery.

45. A method of flooding a subsea pipeline having at least one pig disposed therein with the use of a deployable skid including a control unit, a fluid conduit connectable with the pipeline and at least one pump, pump valve and flow meter associated with the fluid conduit, the pump valve allowing the flow of fluid from the pump into the fluid conduit, the method comprising:
lowering the skid to the sea bed;
fluidly connecting the fluid conduit to the pipeline;
opening a pipeline valve associated with the pipeline;
turning on the control unit and ensuring the pump valve is closed;
allowing the natural flow of sea water through the fluid conduit into the pipeline;
the control unit monitoring the flow rate in the fluid conduit via the flow meter;
the control unit determining when to open the pump valve and turn on the pump without involvement of an underwater vehicle or other external source for controlling operations on the skid necessary for flooding the pipeline;
the control unit opening the pump valve and turning on the pump;
the pump pumping fluid through the fluid conduit into the pipeline; and
the control unit turning off the pump based upon one or more among the flow rate in the fluid conduit, the passage of a certain duration of time or when the pig reaches the distant end of the pipeline, wherein the control unit autonomously controls all operations on the skid relating to flooding of the pipeline without involvement of an underwater vehicle or other external control source for controlling operations on the skid necessary for flooding the pipeline.

46. The method of claim 45 further including at least one battery providing sufficient power to the skid for flooding the pipeline without power from an underwater vehicle or other external source.

47. The method of claim 46 wherein the at least one battery is disposed on the skid, further including connecting an underwater vehicle to the battery to recharge the battery.

48. The method of claim 47 further including
deploying a replaceable battery to the sea floor and connecting the replaceable battery to the skid for providing additional power to the skid,
disconnecting the replaceable battery from the skid and retrieving it to the surface, and
deploying another replaceable battery to the sea floor and connecting it to the skid.

49. A method of hydrotesting a subsea pipeline with the use of a deployable skid and at least one battery associated with the skid and not connected to an underwater vehicle or cable extending to the surface, the skid including a control unit, a fluid conduit connectable with the pipeline and at least one high pressure pump, pump valve and pressure sensor associated with the fluid conduit, the pump valve allowing the flow of fluid from the high pressure pump into the fluid conduit, the method comprising:
lowering the skid to the sea bed;
fluidly connecting the fluid conduit to the pipeline;
turning on the control unit and opening the pump valve;
the pressure sensor measuring the pressure of fluid flowing into the pipeline from the fluid conduit;
the control unit turning on the high pressure pump;
the high pressure pump pumping fluid through the fluid conduit into the pipeline;
the control unit receiving data from the pressure sensor and turning off the high pressure pump when the pressure is at or above a certain level based at least partially upon data received from the pressure sensor; and
the at least one battery providing sufficient power to the pump and control unit for hydrotesting the pipeline, whereby power to the skid from an underwater vehicle or cable to the surface is not required for hydrotesting the pipeline.

50. The method of claim 49 further including the control unit autonomously controlling all operations on the skid relating to hydrotesting the pipeline without involvement of an underwater vehicle or other external control source for controlling operations on the skid necessary for hydrotesting the pipeline.

51. The method of claim 49 further including
the control unit gathering and storing data, and
at least one data link on the skid providing communication between the control unit and at least one external source and allowing the transmission of data between the control unit and the external source.

52. The method of claim 49 further including
the control unit gathering and storing data,
retrieving the skid from the sea bed, and
after retrieving the skid from the sea bed, retrieving data stored in the control unit.

53. The method of claim 49 wherein the at least one battery is disposed on the skid, further including connecting an underwater vehicle to the battery to recharge the battery.

54. The method of claim 53 further including
deploying a replaceable battery to the sea floor and connecting the replaceable battery to the skid for providing additional power to the skid,
disconnecting the replaceable battery from the skid and retrieving it to the surface, and
deploying another replaceable battery to the sea floor and connecting it to the skid.

55. A method of hydrotesting a subsea pipeline with the use of a deployable skid including a control unit, at least one battery, a fluid conduit connectable with the pipeline and at least one high pressure pump, pump valve and pressure sensor associated with the fluid conduit, the pump valve allowing the flow of fluid from the high pressure pump into the fluid conduit, the method comprising:
lowering the skid to the sea bed;
fluidly connecting the fluid conduit to the pipeline;
turning on the control unit and opening the pump valve;
the pressure sensor measuring the pressure of fluid flowing into the pipeline from the fluid conduit;
the control unit turning on the high pressure pump;
the high pressure pump pumping fluid through the fluid conduit into the pipeline;
the control unit receiving data from the pressure sensor and turning off the high pressure pump when the pressure is at or above a certain level based at least partially upon data received from the pressure sensor; and
the at least one battery on the skid providing sufficient power to the pump and control unit for hydrotesting the pipeline without power from an underwater vehicle or other external source.

56. The method of claim 55 further including the control unit autonomously controlling all operations on the skid relating to hydrotesting the pipeline without involvement of an underwater vehicle or other external control source for controlling operations on the skid necessary for hydrotesting the pipeline.

57. The method of claim 56 further including
the control unit gathering and storing data, and
at least one data link on the skid providing communication between the control unit and at least one external source and allowing the transmission of data between the control unit and the external source.

58. A method of hydrotesting a subsea pipeline with the use of a deployable skid including a control unit, a fluid conduit connectable with the pipeline and at least one high pressure pump, pump valve and pressure sensor associated with the fluid conduit, the pump valve allowing the flow of fluid from the high pressure pump into the fluid conduit, the method comprising:
lowering the skid to the sea bed;
fluidly connecting the fluid conduit to the pipeline;
turning on the control unit and opening the pump valve;
the pressure sensor measuring the pressure of fluid flowing into the pipeline from the fluid conduit;
the control unit turning on the high pressure pump;
the high pressure pump pumping fluid through the fluid conduit into the pipeline;
the control unit receiving data from the pressure sensor and turning off the high pressure pump when the pressure reaches or exceeds a certain level based at least partially upon data received from the pressure sensor and autonomously controls all operations on the skid relating to hydrotesting the pipeline without involvement of an underwater vehicle other external source for controlling such operations.

59. The method of claim 58 further including at least one battery providing sufficient power to the skid for hydrotesting the pipeline without power from an underwater vehicle or other external source.

60. The method of claim 59 wherein the at least one battery is disposed on the skid, further including connecting an underwater vehicle to the battery to recharge the battery.

61. The method of claim 60 further including
deploying a replaceable battery to the sea floor and connecting the replaceable battery to the skid for providing additional power to the skid,
disconnecting the replaceable battery from the skid and retrieving it to the surface, and
deploying another replaceable battery to the sea floor and connecting it to the skid.
